(19) United States
(12) Patent Application Publication
(10) Pub. No.: US 2023/0368160 A1
(43) Pub. Date: Nov. 16, 2023

(54) Perpetually Stable Cryptocurrency Coinage Algorithm

(71) Applicants: Philip Muller, New Hope, PA (US); Zachary Muller, New Hope, PA (US)

(72) Inventors: Philip Muller, New Hope, PA (US); Zachary Muller, New Hope, PA (US)

(21) Appl. No.: 17/745,538

(22) Filed: May 16, 2022

Related U.S. Application Data
(63) Continuation-in-part of application No. 17/743,116, filed on May 12, 2022.

(51) Int. Cl. G06Q 20/06; G06Q 20/38

(52) U.S. Cl. CPC G06Q 20/0652; G06Q 20/389

(57) ABSTRACT

An algorithm for creating a cryptographic token or coin which maintains a significantly stable value to be used on a blockchain whereby the cryptographic coinage removes market volatility by being pegged to an index of multiple world currencies thereby maintaining a more stable international value to help facilitate worldwide adoption of blockchain technology and commerce.

### RELATED APPLICATION

This is a Continuation-in-Part claiming priority to U.S. Non-Provisional Utility patent application Ser. No. 17/743,116 filed on May 12, 2022 Entitled; (Perpetually Stable Cryptocurrency Coinage)

Whereby the application Ser. No. 17/743,116 filed on May 12, 2022 dealt more broadly with the invention, sighting the algorithmic methodology, According to one embodiment, this application will serve to focus on one embodiment by clearly describing and claiming a specific algorithm invention.

This application also includes the original drawings and adds an additional drawing and description representing the focus on one embodiment of a specific algorithm while still remaining within the broader scope of the description included in the application Ser. No. 17/743,116 filed on May 12, 2022.

### BACKGROUND/SUMMARY

As was described in the parent U.S. Utility patent application Ser. No. 17/743,116, (as well as the PCT filing on May 12, 2022), and will be further described herein;

Cryptographic coinage and blockchains are growing in usage. As usage grows however, volatility has become a problem.

As of the date of this filing, it has been over the 13 years since cryptocurrencies had first been created. As of the date of this filing there have been over 18,000 different Cryptocurrencies invented and in existence. There are also now over 476 cryptocurrency exchanges. With this growth, cryptocurrencies have become highly speculative. There are some cryptocurrencies considered “Stable coins”, or “wrapped tokens”, whose valuations are pegged to a perceived stable asset.

These are intended to help alleviate this instability; however they are still vulnerable to that asset's valuation volatility and that asset's relevancy and financial strength. Even with the adoption of the so called stable coins and wrapped tokens, their valuations being pegged to hard assets or fiat currencies, each are still capable of extreme price variations which is hindering mainstream world adoption. Some Cryptographic coinage have been linked to a multiple of assets, however these too have been very volatile regarding price stability. Since many Blockchains and Blockchain ledger technologies presents considerable value to business and global society through cross boarder commerce, an algorithm by which a timeless and universally worldwide accepted stabilization of Cryptographic coinage is necessary.

However, even after the now 18,000 attempts over 13 years, this worldwide stabilization has yet to be achieved.

Bitcoin, as well as all other “stable coins” and “wrapped tokens” fall short of addressing the many hurtles necessary for a worldwide adoption of Cryptographic coinage. Although creating a decentralized store of value they rely on either public adoption to give them value or the asset that they are pegged to. That public acceptance by the masses and the simple pegging of valuation to assets is either wildly speculative and/or lacks the stability for the consistent and economically stable worldwide use of blockchain in business and commerce.

The so called cryptographic stable coins and wrapped tokens that are based on pegging their value to a given asset or even currencies do not address the inherent fluctuations of that given asset or currency, nor does it address the devaluation of currencies or the ever shifting world macroeconomics.

Not unlike the way energy cannot be created or destroyed, it can only change forms; the total of the world's consumer spending capability is a static 100% at any given time throughout history. The numeric value of the world's consumer spending capability consistently fluctuates and the geographic and geopolitical allocation of that spending capability also fluctuates. However the total consumer valuation of the world is always 100%.

To solve the problems listed above, my Algorithm most closely matches the ever shifting world macroeconomics and makes it possible, for the first time in thirteen years and after eighteen thousand, (18,000), attempts for a cryptographic coinage value to remain as closely linked to the world total consumer valuation, however and whenever it fluctuates, thereby creating cryptographic coinage valuation stability for worldwide adoption in perpetuity.

### DETAILED DESCRIPTION OF THE INVENTION

The invention is an algorithm which pegs cryptographic coinage to an indexing of multiple world currencies that represents real-time fluctuating values of a multitude of the world currencies, thus eliminating, the volatility and potential devaluation of a currency, or currencies, at any given time while remaining adaptable in real-time to the geo-financial fluctuations that inevitably occur over seconds, days, years and centuries.

In one embodiment the algorithm indexes a multitude of the world's government's currencies in a market capitalization weighted index. In another embodiment the algorithm indexes a multitude of any of the world's currencies in a market capitalization weighted index. Individual currencies in the index are included in the amounts and percentages that correspond to their total market capitalization of the world economy. In one embodiment the algorithm indexes a multitude of the world's premiere currencies at any given time. Since the index fluctuates based on the market capitalization of each currency, the index perpetually provides not just perceived stability to a given coinage, but timeless perpetual worldwide stability regardless of shifting world macroeconomics or geopolitics.

This algorithm which creates a perpetually stable cryptographic coin may be utilized in a decentralized market exchange or a centralized market exchange as well as on any given blockchain. The currencies included in the index by the algorithm are expected to change in valuation and in their respective percentage of the index as well as their potential inclusion in the index given each currencies own volatility and changing predominance of valuation in the world over time.

The algorithm is unique in many ways:
A) The algorithm contains, an indexing of world currencies to best establish a worldwide adoption of cryptographic coinage.
B) The inclusion of a currency in the index is not arbitrary but instead picked by the algorithm. This removes geopolitical effect on the index as well as the cryptographic coinage which utilizes the algorithm enabling better economic stability of the coinage.
C) The algorithm includes each currency's value as it fluctuates over time in the index. This also adds great economic stability to the index as well as the cryptographic coinage which utilizes the algorithm.
D) The algorithm will add or remove currencies as needed to meet the qualification of the index as each of their values fluctuates over time. This feature maintains the desired consistency and superiority of the index and the cryptographic coinage which utilizes the algorithm in perpetuity.

In a preferred embodiment the algorithm will:
Select, a multitude of world's currencies in a manner by which each currency will be included in an index.
The index created by the algorithm will include each of the currencies by value in relation to each of their percentage of the world's total wealth.
The algorithm will assess each currency and value of each currency in relation to all others in the index.
The algorithm will assign a value to a cryptographic coinage in a manner consistent with pegging 100% of the world's total wealth to 100% of the cryptographic coinage that exists at any given time.

As used herein, the singular forms “a,” “an,” and “the” are intended to include the plural forms as well, unless expressly stated otherwise. It will be further understood that the terms “inclusion”, “distribution”, “determined”, “pegged”, “including”, “method”, “methodology”, “indexed”, “index”, “indexing”, and/or “comprising,” when used in this application, specify the presence of stated features, integers, steps, operations, elements, and/or components, but do not preclude the presence or addition of one or more other features, integers, steps, operations, elements, components, and/or groups thereof. It will be understood that when a step or operation is described in this application or shown in an illustration, that the sequence or numbering of the “step” or “steps” or “operation” or “operations” is not intended to indicate the necessity of any given sequence or timing and the procedures and should not be limited by these terms.

It will be understood that when an element is referred to as being, “indexed” or “pegged” to another element, it can be directly connected or coupled to the other element or elements in whole or as a percentage of said elements. Furthermore, “indexed”, “determined”, or “pegged”, as used herein may include any and all combinations of one or more of the associated listed items. The term “near real time” shall be used to indicate approximately the time delay introduced between the occurrence of an event and the use of the processed data. The term “currency” shall be generally used herein as any system of money or store of value in general use in any particular country or countries, territory or territories by any government or power at any specific time. The term “world's total wealth” or “country's total wealth” is used to indicate economic assets which may include hard assets including but not limited to raw materials, gross domestic product, economic assets including but not limited to currency, or any other generally accepted element or measure of value. It will also be understood that, although the terms listed above may be used herein to describe various elements and procedures, these elements and procedures should not be limited by these terms. These terms are only used to distinguish one element or procedure from another without departing from the teachings of the disclosure.

### BRIEF DESCRIPTION OF THE OF THE DRAWINGS

The features, aspects, and advantages of the exemplary embodiments are understood when the Detailed Description is read with reference to the accompanying drawings, wherein:

FIG. 1) illustrates a simplified mechanism of stability for cryptographic coinage.

FIG. 2) illustrates a simplified method for cryptographic coinage indexing of multiple currencies.

FIG. 3) illustrates the portion of the claimed algorithm showing market capitalization weighted indexing of multiple currencies for stabilization of cryptographic coinage.

FIG. 4) illustrates the claimed algorithm of market capitalization weighted indexing of multiple currencies for stabilization of cryptographic coinage.

FIG. 5) illustrates the use of the claimed algorithm and its adoption of use on a blockchain.

### DETAILED DESCRIPTION OF THE DRAWINGS

The listed exemplary embodiments will now be described more fully hereinafter with reference to the accompanying drawings. Exemplary embodiments may however be embodied in many different forms and should not be construed as limited to the embodiments set forth herein. These embodiments are provided so that this disclosure will be thorough and complete and will fully convey exemplary embodiments to those of ordinary skill in the art. Moreover, all statements herein reciting embodiments, as well as specific drawing examples thereof, are intended to encompass both structural and functional equivalents thereof. Additionally, it is intended that such equivalents include both currently known equivalents as well as equivalents developed in the future (i.e., any elements developed that perform generally the same function, regardless of structure or origin, including but not limited to, additional currencies.)

Thus, for example, it will be appreciated by those of ordinary skill in the art that the diagrams, schematics, illustrations, and the like represent conceptual views or processes illustrating exemplary embodiments. The functions of the algorithm and its various elements shown in the figures may be provided through the use of dedicated hardware or software as well as hardware capable, of executing associated software. Those of ordinary skill in the art further understand that the exemplary hardware, software, processes, methods, and/or operating systems described herein are for illustrative purposes and, thus, are not intended to be limited to any particular manufacturer of hardware or software or to be limited to centralized or decentralized blockchain and is not intended to restrict the claims to any one blockchain or currency but rather to include all blockchains and all currencies either now in use, developed, or yet to be developed.

It is understood that any percentages, currencies, any valuation of either percentages or currencies are included in the drawing for reference purposes only and should not restrict the invention and the invention should not be limited by these indicated values, percentages, currencies. These values, percentages, and currencies are only used to help illustrate the invention without departing from the teachings of the disclosure.

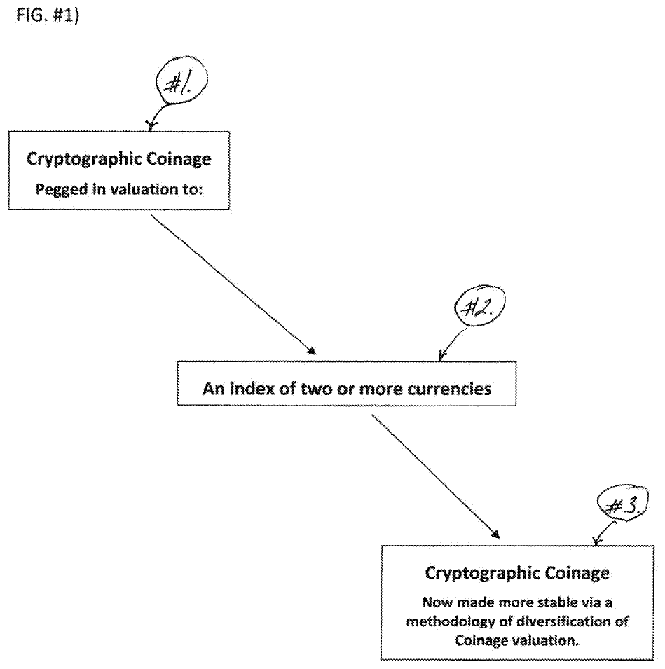

### FIG. 1)

Illustrates a simplified mechanism of stability for cryptographic coinage. The first block (#1) indicates a basic cryptographic coin. The second block (#2) indicates the first block being linked to an index consisting of multiple currencies. The third block (#3) indicates the now much more stable coin.

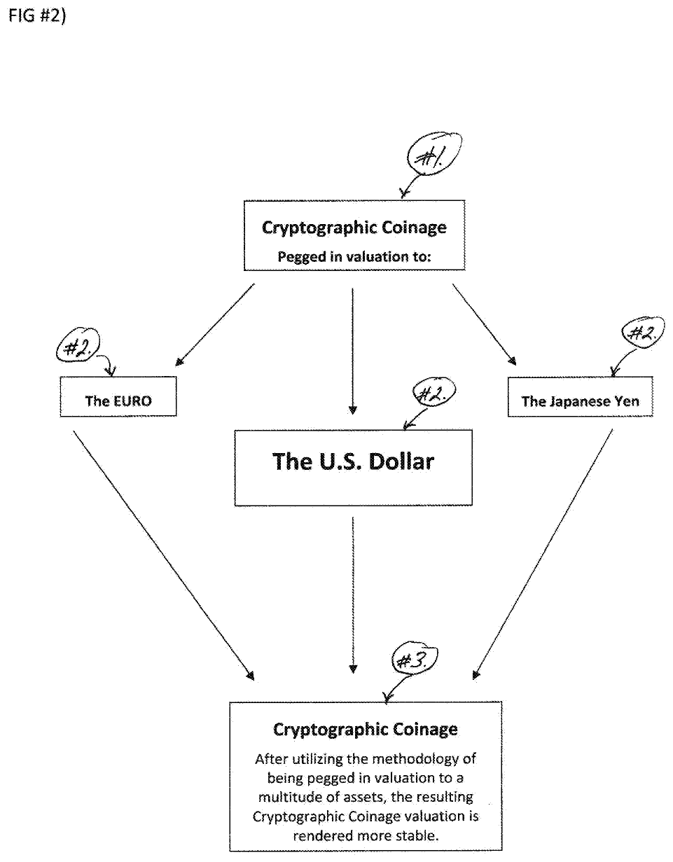

### FIG. 2)

Illustrates a simplified methodology for cryptographic coinage indexing of multiple currencies. The first block (#1) indicates a basic cryptographic coin. The three middle blocks (#2) indicates the first block being linked to an index consisting of multiple currencies. The third block (#3) indicates the now much more stable coin.

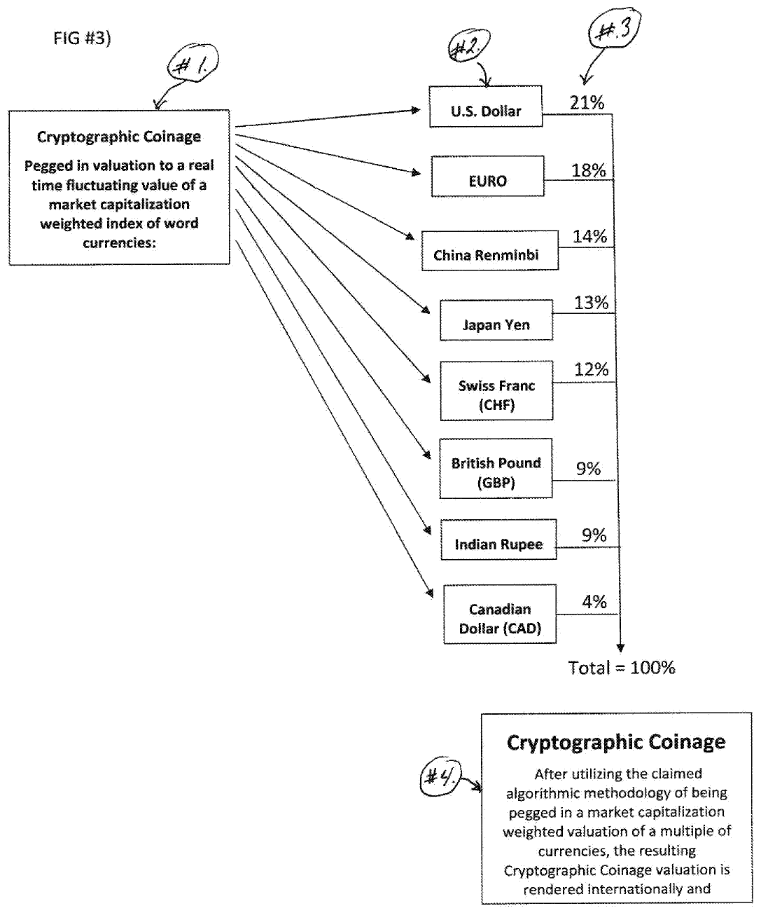

### FIG. 3)

Illustrates an algorithmic methodology for cryptographic coinage market cap weighted indexing, according to exemplary embodiments. The first block (#1), indicates a basic cryptographic coin. The column of blocks to the right (#2), represent the indexing of certain currencies, (the included currencies and their allocations are for example purposes only), the percentages listed (#3) accompanying the individual currencies indicate, (for example purposes only), that each currency in the index will have allocations based on their economic standing at any given time.

The algorithm will adjust according to changes in both the economic standing and percentage of valuation as well as actual valuation of that given currency and will be calculated to derive the index value for the cryptographic coinage shown here as the lower block (#4).

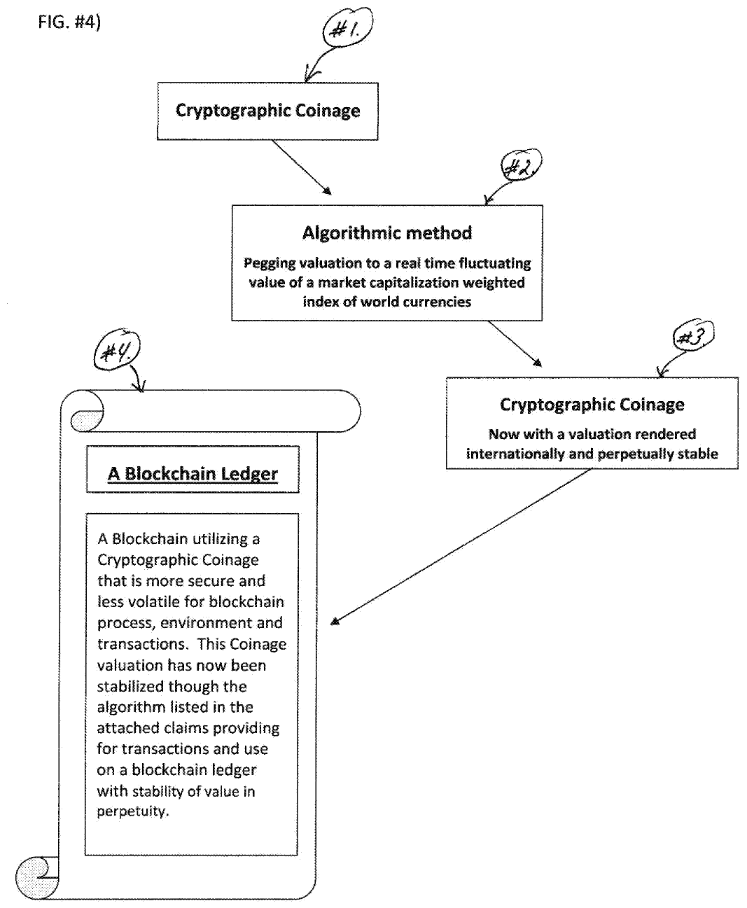

### FIG. 4)

Illustrates the use of the algorithmic methodology for cryptographic coinage market cap weighted indexing and its adoption of use on a blockchain.

The first block (#1), indicates a basic cryptographic coin. The second block down (#2), represents the indexing of certain world currencies utilizing the real-time market cap weighted index of those currencies. The third block (#3), represents the cryptographic coinage now having been valued by the claimed algorithmic methodology, having an internationally and perpetually stable valuation to the world economy. The fourth and final block/graphic (#4), indicates the use of the now exemplary stable cryptographic coin on a blockchain ledger system.

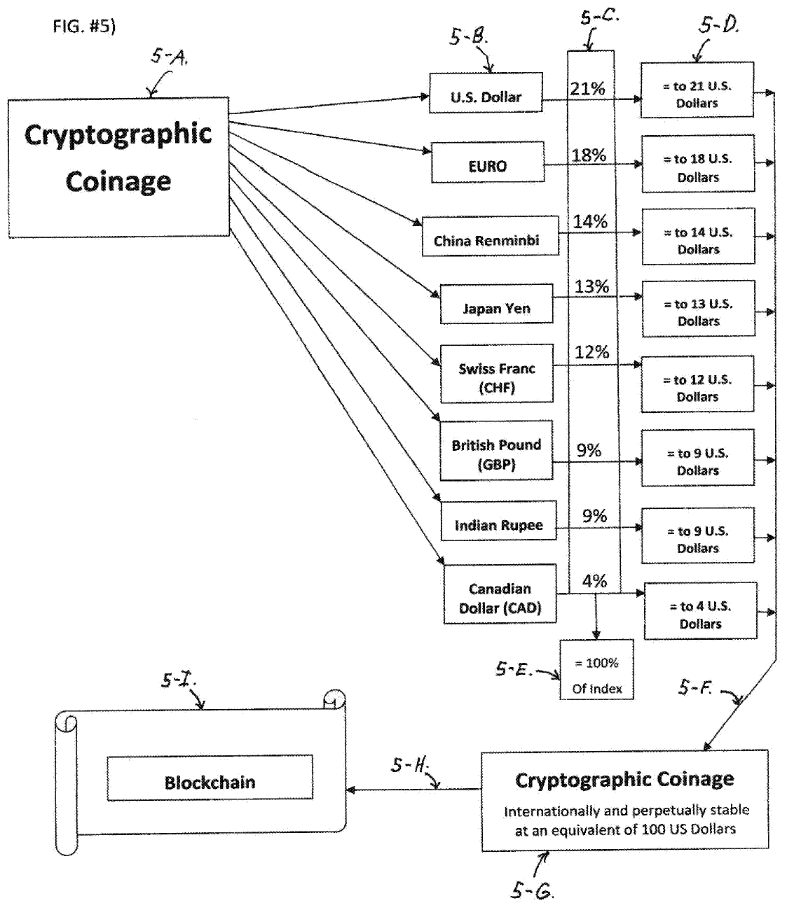

### FIG. 5)

Illustrates an exemplary embodiment of the algorithm for perpetual stabilization of cryptographic coinage as claimed in this application.
Block 5-A. represents a basic cryptographic coin.
Column 5-B. represents the indexing and inclusion in the index of world currencies utilizing a real-time market capitalization weighted index of currencies.
Column 5-C. represents each currency's percentage valuation of weight in the index which fluctuates pursuant to each currency's market capitalization weighted dominance in the world at a given time.
Column 5-D. represents each currency's fiscal valuation in the index which fluctuates pursuant to each currency's market capitalization weighted dominance in the world at a given time.
Block 5-E. represents that the index of currencies is equal to 100 percent of the world's total wealth at a given time.
Line 5-F. represents the pegging of 100 percent of the currencies in the index fiscal valuations at a given time.
Block 5-G. represents the cryptographic coinage after being pegged to the index determined value.
Line 5-H. represents the use of the now perpetually stable cryptographic coinage on a blockchain.
Block 5-I. represents a blockchain utilizing the cryptographic coinage after being pegged to the index determined value.

I hereby claim as my invention:

1. An algorithm including an index of multiple currencies whereby the index generates a value, whereby the value is pegged as a valuation to cryptographic coinage.

2. The algorithm of claim 1. whereby each currency's percentage of inclusion in the index is predicated on that currency's percentage of the world's total wealth.

3. The algorithm of claim 1. whereby a value is assigned to cryptographic coinage pegging the world's total wealth to 100% of the value of the cryptographic coinage.

4. The algorithm of claim 1. whereby a value is assigned to cryptographic coinage pegging the world's total wealth adjusting in real time to 100% of the cryptographic coinage adjusting in real time.

5. The algorithm of claim 1. whereby each currency's valuation in the index fluctuates pursuant to its market capitalization weighted dominance in the world at a given time.

6. The algorithm of claim 1. whereby the inclusion of each currency's valuation in the index contributes to the cryptographic coinage stability of value.

7. The algorithm of claim 1. whereby the algorithm creates a market capitalization weighted index of multiple currencies for use on a blockchain.

1. The index of claim 1. wherein each currency's inclusion in the index is predicated on a market capitalization weighted dominance of the world's total wealth.

9. The cryptographic coinage of claim 1. wherein its intending use is for trading.

10. The cryptographic coinage of claim 1. wherein its intending use is for transactions.

11. The cryptographic coinage of claim 1. wherein its intending use is for transactions on a blockchain.

12. The cryptographic coinage of claim 1. wherein its intending use is for transactions recorded on a centralized blockchain.

13. The cryptographic coinage of claim 1. wherein its intending use is for transactions recorded on a decentralized blockchain.

14. The cryptographic coinage of claim 1. whereby its intrinsic value is determined by a market capitalization weighted index of the valuation of multiple currencies.

15. The cryptographic coinage of claim 1. wherein the cryptographic coinage intrinsic value is determined by a market capitalization weighted index of the valuation of multiple fiat currencies.

16. The cryptographic coinage of claim 1. wherein the cryptographic coinage intrinsic value matches the valuation of a market capitalization weighted index of the valuation of multiple world currencies.

17. An algorithm including an index of multiple currencies whereby the index generates a value consistent with the world's total wealth whereby that value is pegged to the valuation of cryptographic coinage.

18. The cryptographic coinage of claim 17. wherein the cryptographic coinage intrinsic value matches the valuation of a market capitalization weighted index of the valuation of multiple world currencies.

19. The cryptographic coinage of claim 17. wherein its intending use is for transactions on a blockchain.
